(19) United States
(12) Patent Application Publication
(10) Pub. No.: US 2006/0003296 A1
(43) Pub. Date: Jan. 5, 2006

(54) System and method for assessing mathematical fluency

(76) Inventor: David Dockterman, Carlisle, MA (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/157,374

(22) Filed: Jun. 21, 2005

Related U.S. Application Data
(60) Provisional application No. 60/581,565, filed on Jun. 21, 2004.

(51) Int. Cl. G09B 19/02; G09B 3/00; G09B 23/02; G09B 7/00

(52) U.S. Cl. 434/188; 434/322

(57) ABSTRACT

A computer-based assessment that presents basic math facts in an operation and records the amount of time taken to answer each fact correctly. By measuring the latency of the response, the program can accurately determine the facts that are being recalled from memory and those that are solved using a counting or other procedural strategy. Once an initial assessment is completed, a grid is constructed that allows the student and teacher to see the fluent facts as well as those facts that were answered slowly and/or incorrectly. The system uses the grid to begin instruction on the non-fluent facts. Math facts are systematically presented, thereby instructing the student until the facts are mastered.

### CROSS-REFERENCE TO RELATED APPLICATIONS

The present application claims to priority to U.S. Provisional Patent Application No. 60/581,565, filed Jun. 21, 2004, the entirety of which is incorporated herein by reference.

### FIELD OF THE INVENTION

The present invention relates to a teaching tool. In particular, the present system assesses and improves retention of math skills by providing a method for assessing math skills and improving the retention of math skills.

### BACKGROUND OF THE INVENTION

Solid math skills are a prerequisite for school achievement and success in the workplace. Unfortunately, many students do not have the necessary basic math skills for success. In 2003, 23% of fourth graders and 32% of eight graders performed below basic levels in mathematics. One reason for these poor results is students lack fluency in basic math facts. Fluent recall of basic math facts allows students to focus on more complex computations, problem solving, and higher order math concepts.

Psychologists have discovered that humans have fixed limits on the attention and memory that can be devoted to solve problems. One way to overcome these fixed limits is to have tasks become automatic. Mathematics, and in particular, the basic math facts, need to be developed to the point that they are retrieved automatically. In other words, basic math facts must be learned by rote so that the retrieval of the math facts is automatic.

Studies have shown that fluency in basic skills is a necessary prerequisite to higher-level functioning. Studies suggest that children often do poorly because they have failed to master the sub-component processes required to understand and solve math problems. If a student constantly has to compute basic facts, less of that student's thinking capacity is devoted to higher level concepts than a similar student who recalls basic math facts.

Mathematical knowledge can be classified into two categories. The first category is “declarative knowledge” and the second category is “procedural knowledge”. Declarative knowledge can be conceptualized as an interrelated network of relationships containing basic problems and their answers. Procedural knowledge refers to methods that can be used to derive answers for problems lacking pre-stored answers. For example, if presented with the problem 8+2, a student that has a knowledge of the basic facts will recite that 8+2=10 using declarative knowledge. In contrast, a student that has not mastered these basic facts will use procedural knowledge to calculate that 8+2=10 by counting up from 8 until 10 is reached. This procedural knowledge, while yielding the correct answer, can be slow and error-prone.

In the brain, there is a shift in activation patterns as untrained math facts are learned. Instruction and practice cause math fact processing to move from a quantitative area of the brain to an area related to automatic retrieval. This automatic retrieval allows for the substitution of intermediate calculation steps with automatic retrieval. Therefore, students need to develop rapid and errorless recall of basic math facts.

### SUMMARY OF THE INVENTION

Given the importance of fluid recall of basic facts, the main concern is developing declarative knowledge of math facts. The acquisition of math facts generally progresses from procedural knowledge to declarative knowledge. Drill and practice programs demonstrate a positive effect on improving the retrieval speed for facts already being recalled from memory. However, drill and practice have little effect on developing automaticity for non-recalled facts. Consequently, to facilitate the automatic recall, instruction must be focused on non-automatized facts while practice and review are given on facts that already being recalled from memory.

The disclosed system uses a computer-based assessment that presents basic math facts in an operation and records the amount of time taken to answer each fact correctly. By measuring the latency of the response, the program can accurately determine the facts that are being recalled from memory and those that are solved using a counting or other procedural strategy. Latency is determined by measuring the time difference between typing a number (12) and typing the answer when presented with the multiplication fact (3×4) or the like. Once the initial assessment is completed, a grid is constructed that allows the student and teacher to see the fluent facts as well as those facts that were answered slowly and/or incorrectly. The system uses the grid to begin instruction on the non-fluent facts. Math facts are systematically presented, thereby instructing the student until the facts are mastered.

Once a problem/answer relationship is established, the system uses controlled response times to reinforce the memory connection and inhibit the use of counting or other non-automatic strategies. In one embodiment, the controlled response time is between 0.4 and 1.25 seconds, forcing students to abandon inefficient strategies and to retrieve answers rapidly from the declarative knowledge network. In one embodiment, when the controlled response time lapses before the child can respond, or if the answer is incorrect, the program provides corrective feedback by presenting the problem/answer relationship again. This process continues until the correct answer is given in the controlled response time.

### BRIEF DESCRIPTION OF THE FIGURES

FIG. 1 is a depiction of a login screen.

FIG. 2 depicts an assessment screen.

FIG. 3 depicts a fact assessment screen.

FIG. 4 depicts a fact matrix.

FIG. 5 depicts a teaching screen.

FIG. 6 depicts a teaching screen.

FIG. 7 depicts a screen displaying a multimodal teaching approach.

FIG. 8 is a flowchart of the disclosed method according to one embodiment of the invention.

FIG. 9 depicts a system according to one embodiment of the invention.

### DESCRIPTION OF THE PREFERRED EMBODIMENTS

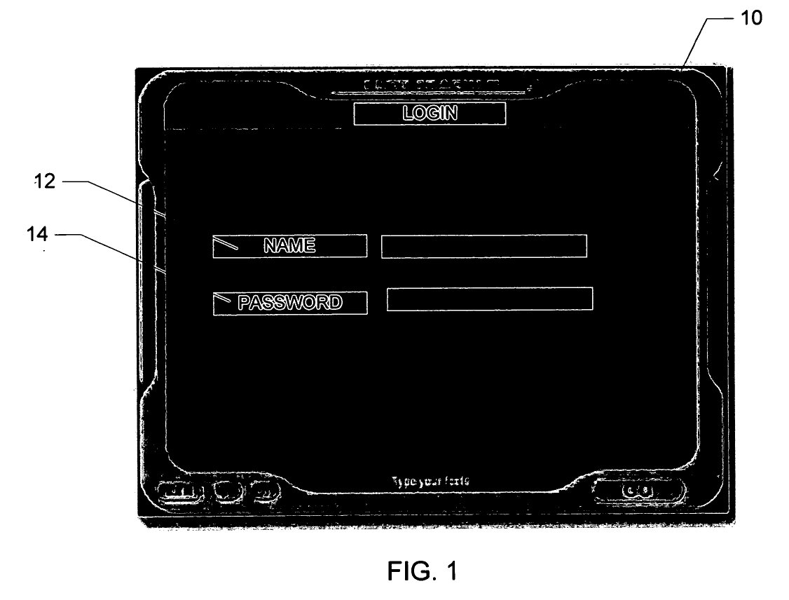

FIG. 1 is a depiction of a login screen according to one embodiment of the invention. This is the first screen that appears when a student initiates the disclosed program. The student's name 12 and password 14 are entered in the provided fields. The student will then press the go button 16 to log into the system. The student login is used to recall a student's assignment, performance, settings, and the like. The settings are preferably stored in a database.

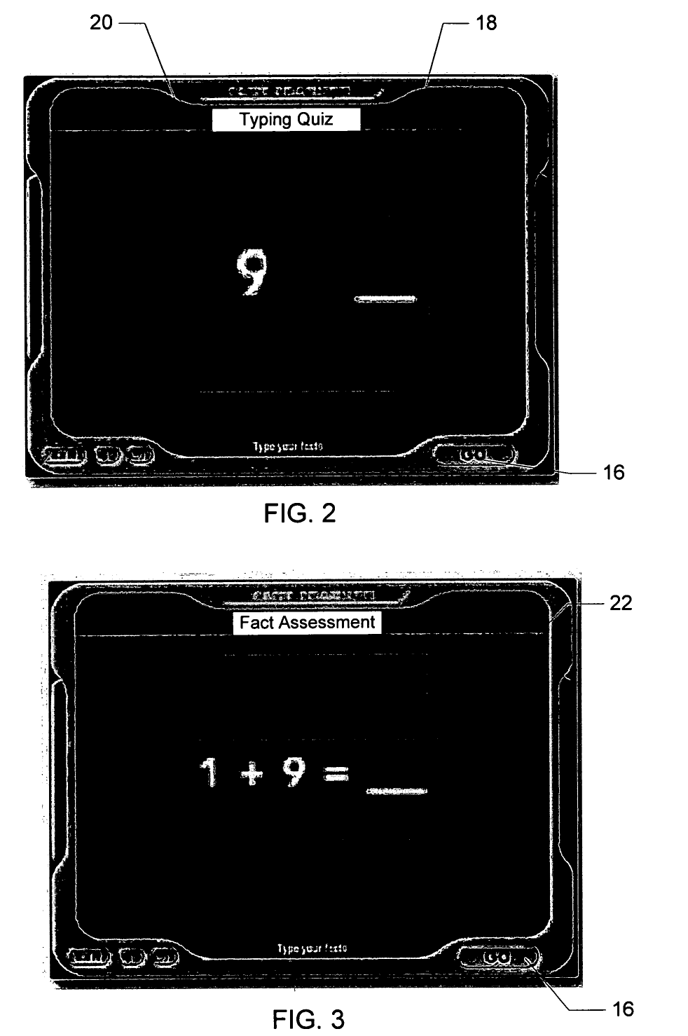

The first time a student logs into the system, or as the student's typing skills improve, the student enters an assessment routine. The first part of the assessment is a typing quiz as shown in FIG. 2. This quiz measures the student's typing abilities. The student's median typing response time is measured. This median typing response time is used for comparison with response times in other parts of the program discussed below.

To determine the student's median typing response time, a number 20 will be displayed on the screen. A field 18 is provided for the student to enter the same number. In one embodiment, once the student types the number, another number is displayed. In this embodiment, there is no need for the user to press the go button 16. Additionally, the user does not have to use the mouse to move the cursor to the area 18 where the number will be entered. In another embodiment, numbers are presented on the screen one at a time. The student enters the displayed number and then presses the space bar or the enter key. The response latency for all of the responses is measured. At the end of the assessment, the median response time for each number is calculated and stored. The standard deviation for all correct responses is calculated to determine if the keyboarding responses are stable.

In one embodiment, the student takes a typing quiz over several subsequent sessions until the data, i.e., the standard deviation, indicates that the keyboarding times have stabilized. Additionally, the typing quiz is given to the student as subsequent modules are completed.

Once the student completes the typing quiz, a baseline for math fact knowledge is determined. While the disclosed system and method can be used for any mathematical operation e.g., multiplication, division, subtraction, etc., it will be described herein utilizing basic addition. As shown in FIG. 3, the student is presented with basic math fact sentences. The student is required to provide the correct answer. For basic addition fact knowledge, the student is presented with all of the math sentences from 0+0 through 9+9.

The initial fact assessment is a dynamic test that adjusts the facts presented based on the student's responses. The students' responses are monitored and, if they respond with automaticity, increasingly challenging problems are introduced. In one embodiment, a teacher or other supervisor would assign a fact range for the student, e.g., 0-9 or 0-12. In another embodiment, the system will adapt and present a fact range commensurate with the student's abilities. However, if the student responds incorrectly or with slow response times, the difficulty of the problems is not increased or may be decreased. In this manner, the student's knowledge of automatic facts can be determined quickly, without undue stress on students who are responding incorrectly.

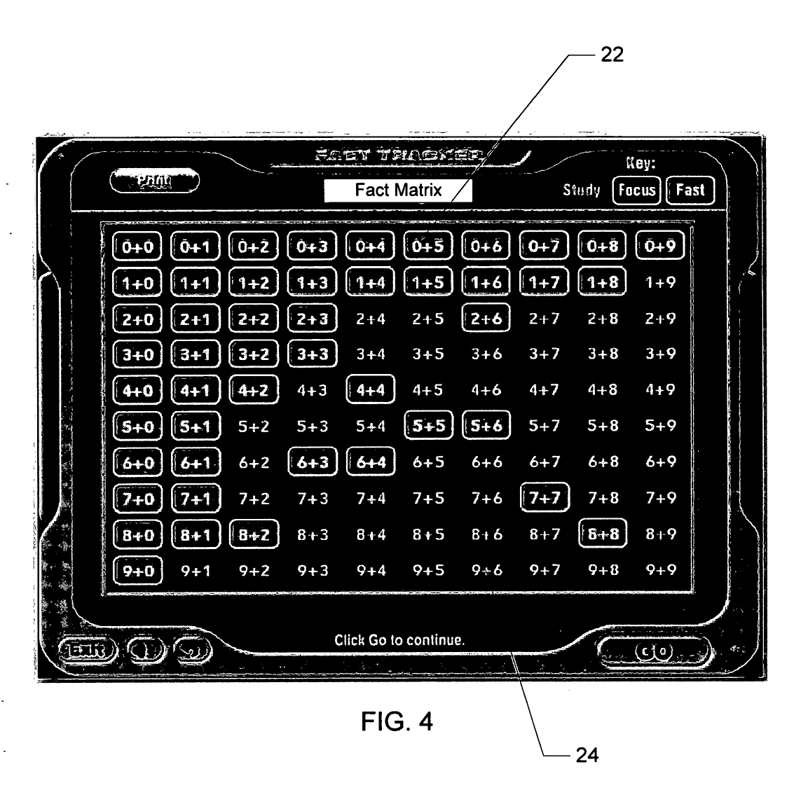

During the fact assessment, data is collected and stored in a data storage section of the system. The collected data includes response times for each correct response. In another embodiment, response times for both the correct and incorrect answers are recorded. At the end of the initial fact assessment, data relating to the fluency status of each fact is stored. This data includes whether the fact was fluent or not on the initial assessment. This fluency fact data is used to generate a fact matrix as shown in FIG. 4.

As shown in FIG. 4, the highlighted cells 22 designate math facts that the student knows fluently. Whereas, the non-highlighted cells 24 are math facts that were either answered incorrectly or not answered fluently. Fluency is determined by verifying that the answer was entered correctly and within the allocated time period. The allocated time is determined by latency. Latency is the time difference between the time to enter a number during the typing quiz and the time to enter a number during the fact assessment period. The latency period is from 0.4 seconds to 1.25 seconds.

Once the fact matrix is complete, a training schedule is established for the student. In the preferred embodiment, the system uses the fact matrix to compile a training schedule. Alternatively, a teacher or other facilitator can prepare the training schedule. The training schedule will concentrate on the math facts that are not declarative knowledge as well as those that were answered incorrectly. The system goal is to teach the facts in a fact matrix, that they are declarative knowledge.

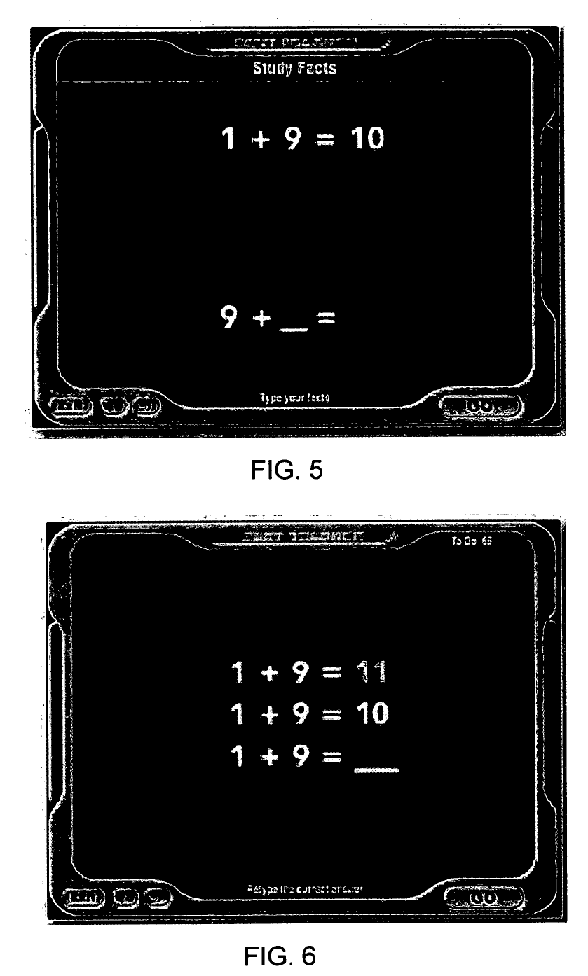

FIG. 5 depicts a screen utilized in developing declarative knowledge for math facts. In a preferred embodiment, no more than two facts and their reversals are presented at a time. The system presents facts in a specific set of target facts until the student can retrieve the answers to the facts consistently without using strategies other than declarative knowledge. The fact pair being learned (4+5 and 5+4) is interspersing of with facts the student has already mastered. The program progressively intersperses additional learned facts among facts being learned. This process forces the student to hold the new fact progressively longer in memory and move it from working to long-term memory. Once the neural pathways are established, they can be reinforced in the games, which focus only on facts that have been learned, with an emphasis on recently learned facts. In one embodiment, the software adjusts game speed to increase recall speed of the facts.

FIG. 6 depicts a typical screen used in developing math fact associations. A student is presented with the same problem multiple times. The repetitive introduction of the same math facts results in the fact relationship necessary to develop the declarative knowledge.

In one embodiment, in order to construct the memory relationship between the fact sentence and the answer, a student is required to type each newly introduced fact. By generating the problem and answer pair, the students connect the two elements together. This relationship eventually will establish the declarative knowledge necessary for academic success.

Once a problem and answer relationship is established, a controlled response time is used to reinforce the memory connection and inhibit the use of non-automatic strategies. A controlled response time is the amount of time allotted to retrieve and provide the answer to fact. In one embodiment, the system uses a controlled response time of 1.25 seconds. If the controlled response time lapses before a response is provided by the student or the student's response is incorrect, corrective feedback is used to reinforce the problem answer relationship. Corrective feedback includes repeating problems and games relating to the problems that were answered incorrectly or slowly. This scenario repeats until the correct answer is given in the controlled response time.

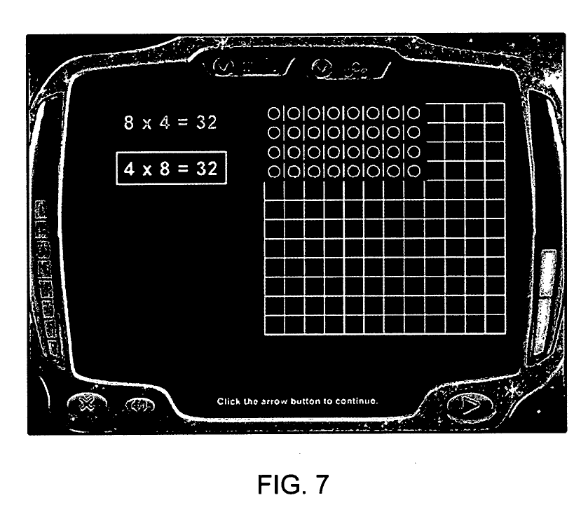

FIG. 7 depicts one variation of a screen used to develop the problem/answer relationship. FIG. 7 depicts a multiplication screen where the relationship between 4×8=32 is shown as a number sentence as well as graphically. While a multiplication fact is portrayed in FIG. 7, other mathematical functions are also displayed graphically. Additionally, in one embodiment, the math facts are presented linguistically. In this embodiment, the math fact is presented audibly by the system and the student is instructed to repeat the math fact aloud. In many instances, the multiple presentations of facts are beneficial to the student.

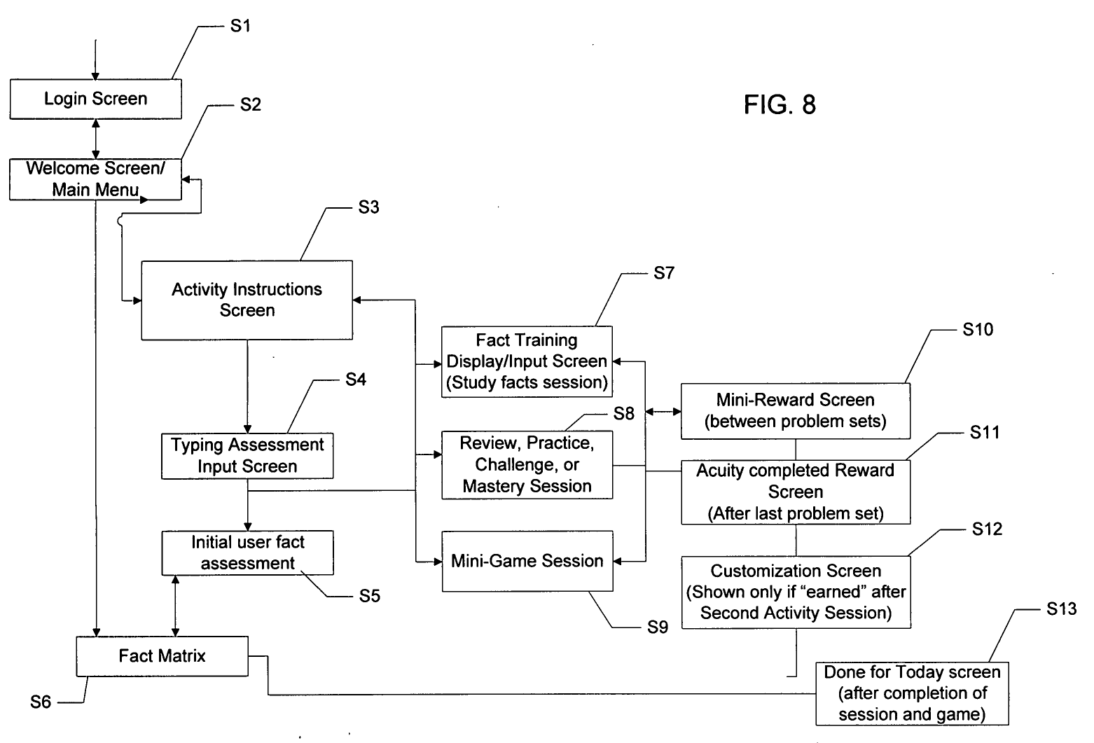

FIG. 8 depicts a flow chart for one embodiment of the invention. As disclosed, at step S1, a student logs into the system and is presented with a welcome screen or main menu (step S2). The student can access the fact matrix if the student is a returning student or, if this is the first time a student is using the system, the student is presented with an instruction screen (step S3). The first time a student accesses the system or, at various times throughout the student's use of the system, a typing assessment screen is presented to the student. The typing assessment is used in conjunction with the initial user fact assessment at step S5 to create the fact matrix shown in FIG. 4. Once the facts matrix is developed, fact training begins (step S7). Additionally, training and mastery sessions are performed in steps S8 and S9. In the training and mastery steps, the student is presented with review, practice, challenge, or master sessions or, alternatively, the student plays a mini-game which also aids in the development of the problem/solution relationship. After the training sessions, the student is presented with a mini-reward screen (step S10). The mini-reward screen is displayed between problem sets where the student provides accurate responses using less than the latency time period. After the last problem set in a given section, a student will receive a reward screen. Finally, the student is able to log out after completion of a session (step S13).

It should be noted that the latency is measured at the machine the student is using. In one embodiment, the program aggregates latency for a given demographic. If a student falls outside of a standard deviation for latency, an instructor will be notified. This prevents a student from intentionally establishing a low-latency baseline thereby providing the student with additional time to provide the answer to a given math fact question.

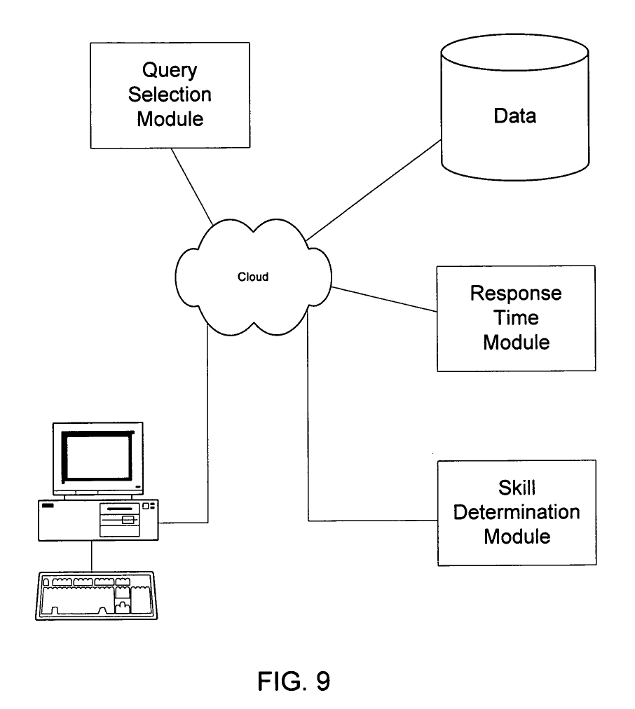

FIG. 9 depicts a system according to the present invention. While the system is depicted as a distributed network, the entire system may be on a single computer. Alternatively, portions of the system can be distributed. The system includes a database that stores data for each student, questions, a query selection module that chooses a mathematical skill from the database, a response time measurement module that measures the time between presentation of the query and an inputted response; and a skill determination module that determines a student's current level.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

We claim:

1. A method of assessing and improving a student's retention of math skills using a computer, said method comprising:
presenting a plurality of queries concerning a mathematical skill;
measuring a student's answer time to each of said plurality of queries;
determining whether said answer times indicate that the student has automatic recall of said mathematical skill;
constructing a knowledge map for the student based in part on the student's automatic recall of said mathematical skill; and
developing a lesson plan for the student based in part on the knowledge map.

2. The method of assessing and improving a student's retention of math skills according to claim 1, further comprising:
establishing the student's baseline response time; and
determining a difference between the response time and the answer time.

3. The method of assessing and improving a student's retention of math skills according to claim 2, wherein the step of determining whether said answer time indicates that the student has automatic recall of said mathematical skill further comprises:
comparing the difference between the response time and the answer time to a standard,
wherein automatic recall is determined if the difference is less than the standard.

4. The method of assessing and improving a student's retention of math skills according to claim 3, wherein the step of establishing the student's baseline response time further comprises:
presenting the student with a numeral;
measuring the response time for the student to type the numeral; and
repeating the presenting and response measurement steps until a median is calculated.

5. The method of assessing and improving a student's retention of math skills according to claim 3, further comprising:
presenting queries to the student until the difference is less than the standard.

6. The method of assessing and improving a student's retention of math skills according to claim 5, further comprising:
presenting a subsequent query concerning the mathematical skill to the student, wherein the subsequent query is based on the student's automatic recall of said mathematical skill.

7. A method of assessing and improving a student's retention of math skills using a computer, said method comprising:
presenting a first query concerning a mathematical skill;
measuring a student's answer time to said first query;
determining whether said answer time indicates that the student has automatic recall of said mathematical skill;
presenting a second query concerning the mathematical skill to the student, wherein the second query is based on the student's automatic recall of said mathematical skill.

8. The method of assessing and improving a student's retention of math skills according to claim 7, further comprising:
establishing the student's baseline response time; and
determining a difference between the response time and the answer time.

9. The method of assessing and improving a student's retention of math skills according to claim 8, wherein the step of determining whether said answer time indicates that the student has automatic recall of said mathematical skill further comprises:
comparing the difference between the response time and the answer time to a standard,
wherein automatic recall is determined if the difference is less than the standard.

10. The method of assessing and improving a student's retention of math skills according to claim 9, wherein the step of establishing the student's baseline response time further comprises:
presenting the student with a numeral;
measuring the response time for the student to type the numeral; and
repeating the presenting and calibrating steps until a median is calculated.

11. The method of assessing and improving a student's retention of math skills according to claim 9, further comprising:
presenting queries to the student until the difference is less than the standard.

12. The method of assessing and improving a student's retention of math skills according to claim 11, further comprising:
constructing a knowledge map for the student based in part on the student's automatic recall of said mathematical skill; and
developing a lesson plan for the student based in part on the knowledge map.

13. A system for assessing and improving a student's retention of math skills, said system comprising:
a database;
a query selection module that chooses a mathematical skill from the database and presents the a query related to said mathematical skill;
a response time measurement module that measures the time between presentation of the query and an inputted response; and
a skill determination module that determines whether the time indicates that the student has an automatic recall of said mathematical skill.
